(19) United States
(12) Patent Application Publication
(10) Pub. No.: US 2024/0149778 A1
(43) Pub. Date: May 9, 2024

(54) CONFIGURABLE VEHICLE LIGHTING SYSTEM WITH MODULAR LIGHTS

(71) Applicant: Xin DONG, Bastrop, TX (US)

(72) Inventor: Xin DONG, Bastrop, TX (US)

(21) Appl. No.: 18/501,984

(22) Filed: Nov. 3, 2023

Related U.S. Application Data
(60) Provisional application No. 63/422,423, filed on Nov. 3, 2022.

(51) Int. Cl. B60Q 1/00; B60Q 1/08; B60Q 1/24; H05B 47/105

(52) U.S. Cl. CPC B60Q 1/0076; B60Q 1/08; B60Q 1/24; H05B 47/105

(57) ABSTRACT

Embodiments of the present disclosure relate to a vehicle lighting system with modular lights. The vehicle lighting system may include a control hub and one or more modular lights. A modular light may include one or more light cores assembled on an assemble frame module. Each light core may include a light source module and an optic module. The light core may be an illuminating light core or a signal light core. The module light may further include a decorative frame module.

### CROSS-REFERENCE TO RELATED APPLICATIONS

This application claims priority to U.S. Provisional Application Ser. No. 63/422,423 filed Nov. 3, 2022, which is incorporated by reference in its entirety.

### FIELD

The present disclosure relates to vehicle lighting systems. Particularly, embodiments of the present disclosure relate to a configurable vehicle light system with modular lights.

### BACKGROUND

Motor vehicles contain numerous lighting devices for both interior and exterior illumination. For example, exterior vehicle lighting devices may perform stop lamp functions, tail lamp functions, headlamp functions, daytime running light functions, dynamic bending light functions, and fog lamp functions. Typically, there are various standards and requirements by government or insurance agencies to regulate these functions for safety reasons. To meet these standards and requirements, a vehicle typically uses multiple single-function lighting devices, each designated to perform a single function, resulting in a variety of vehicle lamps in each vehicle. Upgrading, replacing, and maintaining vehicle lights are usually different for different models of vehicles and different for different lights in the same vehicle.

Therefore, there is need for a flexible vehicle lighting system for easy configuration, upgrading, and maintenance.

### SUMMARY

The present disclosure includes vehicle lighting systems and methods for manufacturing and operating thereof. Particularly, embodiments of the present disclosure provide a vehicle lighting system with modular lights configurable for various lighting functions in a vehicle.

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. It is to be noted, however, that the appended drawings illustrate only typical embodiments of this disclosure and are therefore not to be considered limiting of its scope, for the disclosure may admit to other equally effective embodiments.

FIG. 1A is a plan view of lighting patterns of various light functions for a vehicle.

FIG. 1B includes schematic side views and top views of various driving lights on a vehicle.

FIG. 2A is a schematic block graph of a vehicle lighting system according to embodiments of the present disclosure.

FIG. 2B is a schematic block diagram of the control hub 202 according to the present disclosure.

FIG. 2C is a schematic block graph of a vehicle lighting system with adaptive control according to embodiments of the present disclosure.

FIG. 3A is a schematic block graph of a modular light according to embodiments of the present disclosure.

FIG. 3B is a schematic block graph of a modular light according to embodiments of the present disclosure.

FIG. 4A includes various views of an exemplary modular light according to the present disclosure.

FIG. 4B includes exploded views of the modular light of FIG. 4A.

FIGS. 5A and 5B include examples of modular lights 400 assembled with different combinations.

FIGS. 6A-6B include various views of an exemplary signal modular light according to the present disclosure.

FIG. 6C includes modular signal lights of various shapes according to embodiments of the present disclosure.

FIG. 7 includes examples of modular lights assembled with signal modular lights.

FIG. 8A is a schematic view of the modular lights according to the present disclosure used as after-market vehicle lightings or off-road drive modules

FIG. 8B is a schematical view of the modular lights used as OEM lightings.

FIG. 9 includes various type of vehicles on which the vehicle lighting systems according to the present disclosure may be used.

FIGS. 10A-100 are various exemplary modular lights according to present disclosure.

FIGS. 11A and 11B schematically demonstrate the exemplary modular lights installed on a consumer vehicle.

FIGS. 12A and 12B schematically demonstrate the exemplary modular lights installed on a commercial transport vehicle.

FIGS. 13A-13J schematically demonstrate a control box according to the present disclosure.

FIGS. 14A-14D schematically demonstrate one application of modular vehicle lights according to the present disclosure.

FIG. 15 schematically demonstrates another application of the modular vehicle lights according to the present disclosure.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present disclosure relate to a vehicle lighting system with modular lights. The term “vehicle” or other similar term used herein are inclusive of motor vehicles in general such as land vehicles, watercrafts, aircrafts, that is propelled by motors, which may be driven by fuels derived from resources other than petroleum, electricity, hydrogen, or combinations thereof. For example, vehicles may include passenger automobiles such as sedans, sport utility vehicles, buses, trucks, and the like, transport vehicles such as commercial fleet vehicles, industrial vehicles such as tractors, skeet gears, excavators, and the like, powersports vehicles.

Vehicles are typically equipped with various lightings for illuminating to perform intended functions and/or signaling. For example, a vehicle may include headlamps, taillights, fog lights, spotlights, turn signals, backup lights, and interior lights. Some vehicles lights are required and must be installed at certain locations of the vehicle and meet particular lighting pattern for the vehicle to be straight legal. Other vehicle lights may be optional, auxiliary, or limited to operate when the vehicle is off road.

A vehicle may include front lights 102 to provide illumination for the driver. Front lights may provide a low beam lighting pattern and a high beam lighting pattern. A vehicle may optionally include fog lights 104 configured to provide diffused lighting pattern particularly suitable for driving in a foggy condition. A vehicle may include parking lights which provide illumination and signal when the vehicle is parked. A vehicle also includes various signal lights, such as side turn signal lights, side signal and warning lights. Sometimes, a vehicle may include some off-road lights for driving or working, such as spotlights, flood lights.

On the back side, a vehicle may include stop light to provide signal that the vehicle has stopped moving. A vehicle may include reserve lights to indicate that the vehicle is moving backwards. Side signal and warning lights provide turning signals and dimensions of the vehicle. A vehicle may include fog lights on the back side, parking lights, license plate lights, trunk lights, rock lights, and interior lights.

The various lights not only have different brightness, color, timing of lighting, but also have different lighting patterns which enable the beam of particularly lights to have certain brightness and to reach certain spatial areas. Most states, countries, or regions which utilize motor vehicles have various requirements and standards that a vehicle must meet to be legally use roadways. For example, in the United States, Federal Motor Vehicle Safety Standard (FMVSS) specifies various maximum and minimum photometric intensity values (based on angle) for headlamps.

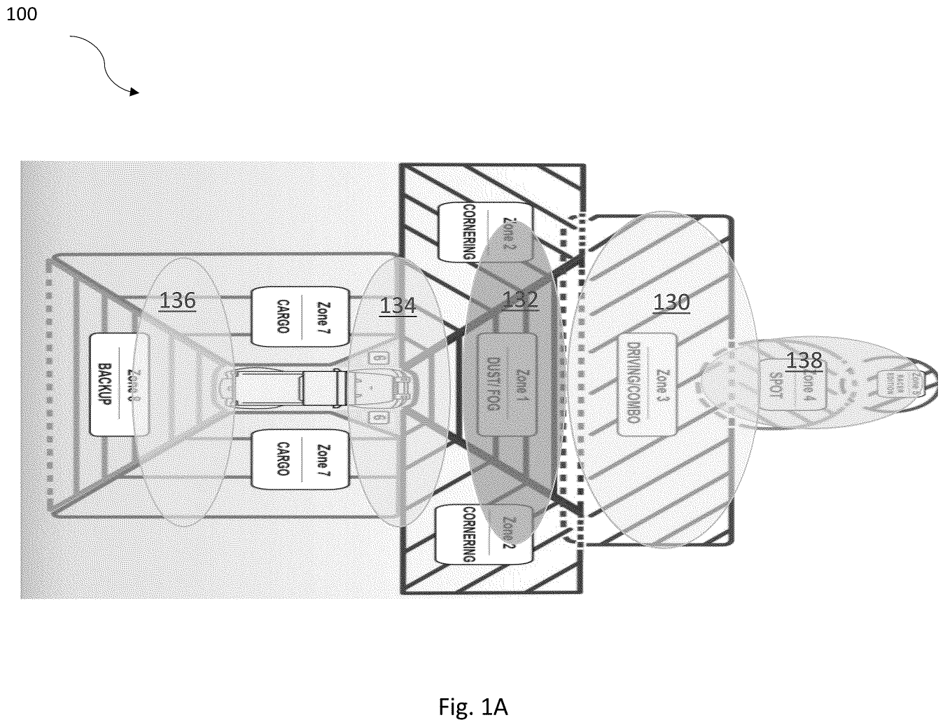

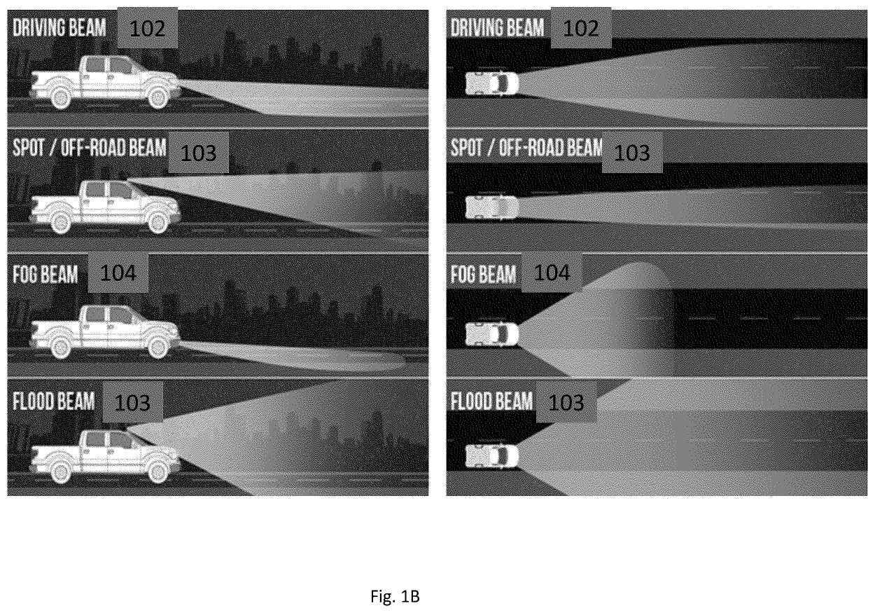

A lighting pattern typically refers intensity distribution and range of light beams from each vehicle light. FIG. 1A is a plan view of illuminating ranges of various light functions for a vehicle. FIG. 1A schematical illustrates lighting patterns of various lights in x-y plane relative to the vehicle 100. Areas around a vehicle may be divided into various zones, such as zones 1-8 in FIG. 1A. Various lights on a vehicle are designed to provide illumination at a certain distance from the vehicle in each zone. For example, the front lights 102 are designed to illuminating zone 3 in a range 130. The fog lights 104 are designed to illuminate zone 1 and zone 1 in a range 132. The various signal lights are designed to illuminate ranges 134, 136 from the vehicle 100. Off-road lights 103, such as spotlights, are designed to illuminate with a range 138.

The lighting patterns also have different heights and angular patterns. FIG. 1B includes schematic side views and top views of various lights on a front light. Particularly, FIG. 1B illustrates lighting range and arial distribution of a low beam of a vehicle headlight 102, a spotlight beam on an off-road light 103, a fog light 104, and a flood beam of the off-road light 103.

Embodiments of the present disclosure provide a vehicle lighting system using modular lights to implement various lights in a vehicle. Modular lights enable easy and low-cost design configuration, update, maintenance, and replacement.

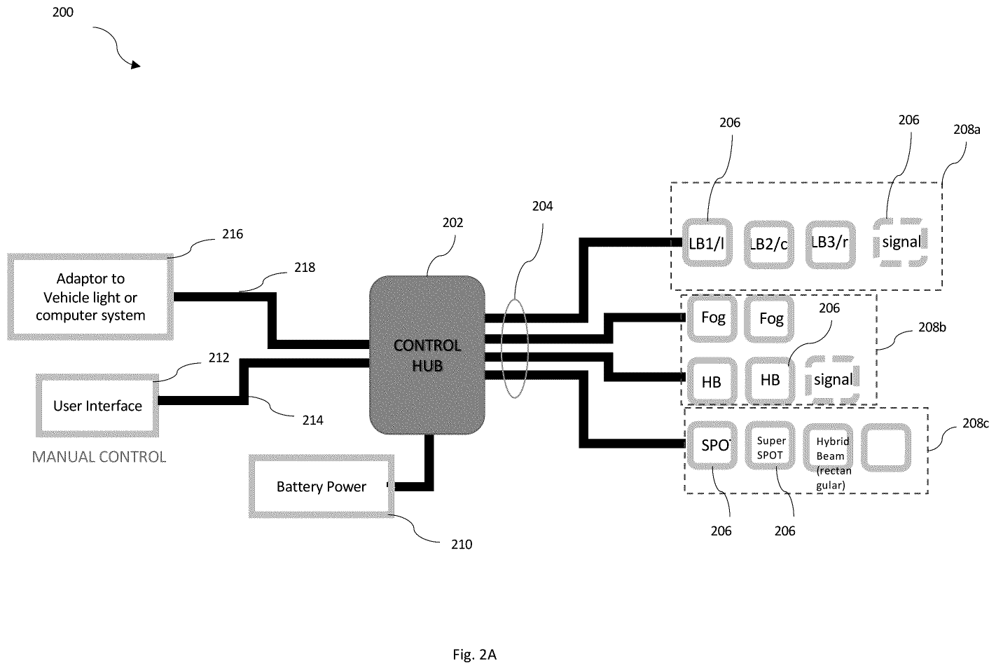

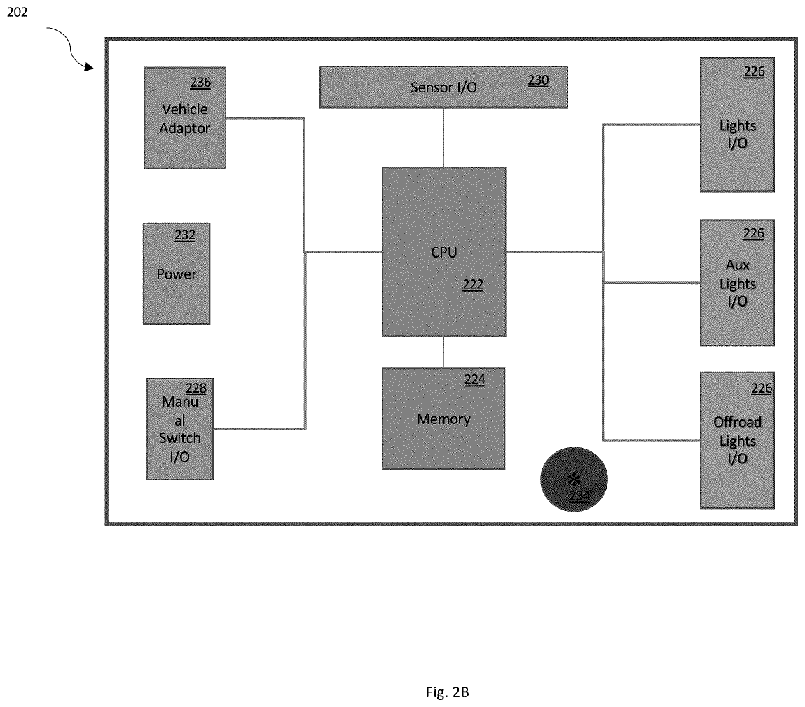

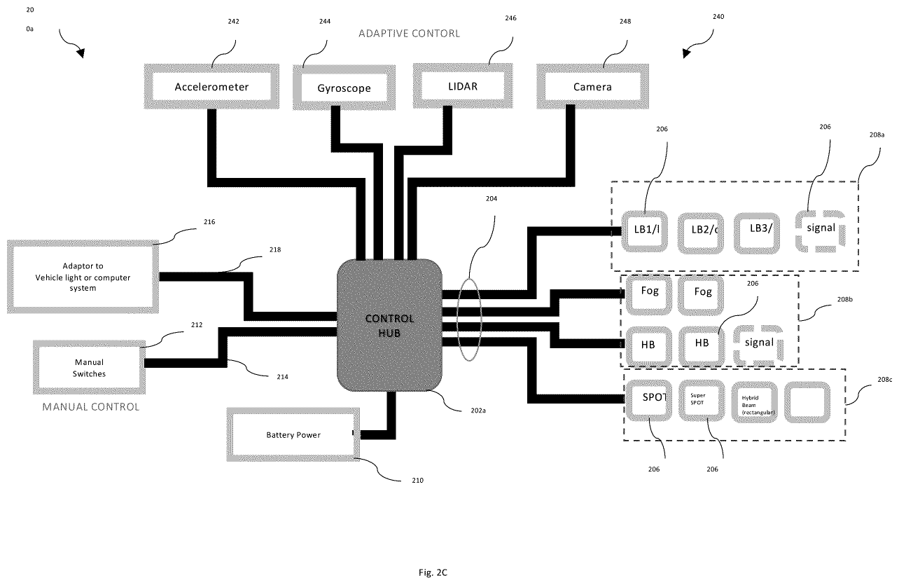

FIG. 2A is a schematic block graph of a vehicle lighting system 200 according to embodiments of the present disclosure. The vehicle lighting system 200 includes a control hub 202 configured to control a plurality of modular lights 208 according to embodiments of the present disclosure. The control hub 202 may be disposed in a convenient location in a vehicle, for example in the trunk, the cabin, or under the hood. The control hub 202 are connected to the plurality of modular lights 206 installed on different locations on the vehicle via cables 204.

In some embodiments, the vehicle lighting system 200 includes a power unit 210 to power the control hub 202 and the modular lights 206 connected thereof. In some embodiments, the power unit 210 may be an adaptor connected to the existing power in the vehicle, such as the vehicle battery. In other embodiments, the power unit 210 may include a battery pack independent from the vehicle. The battery pack may be charged by the engine or the vehicle battery. In other embodiments, the power unit 210 may include an independent power source, for example a generator.

In some embodiments, the vehicle lighting system 200 includes a user interface 212. The user interface 212 may be connected to the control hub 202 via connection 214 to allow the driver to control the modular lights 206. The connection 214 may be wired or wireless connection. In some embodiments, the user interface 212 may include a switch panel to allow the users to turn on and off the individual modular lights 206. In some embodiments, the switch panel may include a group of on and off buttons. In other embodiments, the switch panel may be a touch a screen with software displaying various buttons. In some embodiments, the user interface 212 also includes indicator lights to show status of modular lights 206 in the vehicle lighting system 200. In some embodiments, the user interface 212 further includes a switch configured to switch between a manual control mode and an automatic control mode when the control hub 202 is equipped with automatic control function. In some embodiments, the user interface 212 may be integrated with the vehicle control system, such as integrated with the factory control panel on the dashboard or rearview mirror.

In some embodiments, the vehicle lighting system 200 may include an adaptor 216 to the existing vehicle light control or computer system. The adaptor 216 may be connected to the control hub 202 via a connection 218. The connection 218 may be wired or wireless connection. The adaptor 216 may be specific to make and model of vehicles. The adaptor 216 allows the control hub 202 to coordinate with the existing vehicle light control or computer system to turn on and off the particular modular lights 206, for example when the modular lights 206 in the vehicle lighting system 200 include driving lights, signal lights, or auxiliary driving lights.

In some embodiments, the vehicle lighting system 200 is configurable to drive vehicle lights for various functions. For example, the control hub 202 may be configured to drive essential lights 208a, auxiliary lights 208b, and off-road lights 208c, or a combination thereof. The essential lights 208a may include low beam, essential signal lights, such as break lights, turn signals, reverse lights, dimensional lights, and other required lights for a vehicle to legally on the road according to the local law. The auxiliary lights 208b may include high beam, fog lights, signal lights, and other lights that a vehicle may optionally turn on while driving on the road according to the local law. The auxiliary lights 208b are optional but still under regulation of local laws. The off-road lights 208c may include spotlights, working lights, signal lights, and any lights that can only turn on while the vehicle is not on the road or not running.

In some embodiments, the vehicle lighting system 200 may be configured to selectively support one group, two groups, or all of the essential lights 208a, auxiliary lights 208b, and off-road lights 208c by choosing different control hubs or configuring the control hubs.

In some embodiments, the control hub 202 may include one or more printed circuit boards (PCB) on which a processor, such as a CPU, memories, and various circuit modules may be formed or disposed. The printed circuit board may be placed in a housing, wherein various connections/interfaces to the lights, control panels, sensors, power supply, vehicle controller may be assembled. In some embodiments, the control hub 202 may include a climate control device configured to cool or heat the electronic components on the printed circuit board to insure proper function.

FIG. 2B is a schematic block diagram of the control hub 202 according to the present disclosure. As shown in FIG. 2B, the control hub 202 may include a CPU 222 and memory 224. A software program may be stored in the memory 224 and operable to coordinate and control various lights connected to control hub 202 according to the vehicle operating condition and/or manual input from the driver.

The control hub 202 further includes various input/output interfaces configured to receive and send signals/commands and/or provide drive currents. In some embodiments, the control hub 202 includes light I/O 226 configured to send command and drive current to various lights. In some embodiments, the light I/O 226 may be identical to and programmable to turn on and off various lights by operating software. In other embodiments, the light I/O 226 may be light specific satisfy the load of the different lights. For example, the light I/O 226 may include drive circuits to modular lights to be connected. The modular lights connected to the light I/O 226 receives both on/off command and drive current from the light I/O 226. In some embodiments, the light I/O 226 may be modular circuit boards specific to various light groups, for example, modular circuit boards for the essential lights, the auxiliary lights, and the off-road lights.

The control hub 202 may be customized by selecting one or more modular circuit boards to drive various lights. In some embodiments, the control hub 202 may include a control panel I/O 228 to connect with a user control panel, such as the user interface 212. In some embodiments, the control panel I/O 228 may include a wireless communication means.

In some embodiments, the control hub 202 also includes a sensor I/O 230 configured to connect with one or more sensors installed on the vehicle. The sensor I/O 230 allows the control hub 202 to receive measurements from various sensors and to enable automatic control.

The control hub 202 may include a power unit 232 configured to connect with one or more external power supplies. For example, the power unit 232 may include an AC/DC converter to convert external AC power, such as an alternating power from a generator to DC power needed by the circuit components, and/or by the lights connected to the control hub 202. The power unit 232 may also include DC/DC converter to convert DC power, such as power supplied by the vehicle battery, to DC power level needed by the circuit components and/or the lights. T

The control hub 202 may further include a vehicle adaptor 236 configured to connect with a vehicle's light control system or central controller. The vehicle adaptor 236 may include a standard connection to allow the control hub 202 to be plugged into a vehicle as an auxiliary device. In some embodiments, the vehicle adaptor 236 may include a wireless communication means to connect with the vehicle.

In some embodiments, the control hub 202 may include a climate control unit 234 to heat and/or cool the various electronic components in the control hub 202. In some embodiments, the climate control unit 234 may include a ventilation fan, a temperature sensor, and a ventilation valve.

FIG. 2C is a schematic block graph of a vehicle lighting system 200a with according to embodiments of the present disclosure. The vehicle lighting system 200a is similar to the vehicle lighting system 200 except that the vehicle lighting system 200a includes a sensor panel 240 connected to a control hub 202a. The control hub 202a may include hardware and software operable to receive and process measurements from the sensor panel 240 to achieve adaptive driving beam (ADB) technology.

As discussed above, installation and operating specifications of vehicle lamps are regulated by law. Particularly vehicle headlamps must comply with government regulations to generate regulated lighting patterns for road safety. Typically, vehicle headlamps may project low beam patterns and high beam patterns. Generally, vehicle headlamps are required to maintain the low beam pattern to ensure lighting for the driver and prevent a dazzle effect to the drivers of oncoming vehicles driving in the opposite direction or the drivers of preceding vehicles in the same driving direction. During high-speed driving or in a low light area, the high beam pattern is desired and sometimes necessary for safe driving. When driving with the high beams on, the driver is required to switch from the high beam to the low beam pattern when approaching incoming vehicles on the opposite direction or preceding vehicles in the same direction. Traditionally, high beams are switched on and off manually by the driver. Recently, headlamps with ADB technology were introduced to automatically switch between high beam and low beam patterns according to the driving condition. Existing ADB headlamps may use physical shutters within the headlamp assembly or selectively disable a matrix of LEDs to convert between high beam pattern and low beam pattern. The existing ADB headlamps are complicated and expensive. The vehicle lighting system 200a enables ADB technology by automatically switching between modular lights with low beam optics and modular lights with high beam optics, as discussed below in detail.

The sensor panel 240 may include various sensors used to detect driving conditions, such as lighting, vehicle speed, positions and locations of preceding vehicles and approaching vehicles, and other conditions. The sensor panels 240 may include a plurality of sensors to provide collaborative measurements for precise detection parameters of the driving conditions, for example, vehicle speed and acceleration, vehicle turning angle and speed, position and speed of oncoming vehicles and preceding vehicles, intensity of available external lights, and other parameters related to determine headlamp lighting patter. To improve accuracy of the measurements, the sensor panel 240 may include redundant sensors, for example using two or more same type of sensors to measure the same parameter or using two or more different types of sensors to measure the same parameter. In some embodiments, the sensor panel 240 may include, but not limited to, an accelerometer 242, a gyroscope 244, one or more laser imaging detection and ranging (LIDAR) sensors 246, one or more cameras 248, and other suitable sensors. For example, GPS sensors and infrared sensors may be included.

The accelerometer 242 measures the vehicles linear acceleration. Measurements of the accelerometer 242 may be used by the control hub 202a to determine the vehicle's motion and acceleration.

The gyroscope 244 measures angular velocity of the vehicle. Measurements of the gyroscope 244 may be used to determine the vehicles' turning angle and turning speed.

The LIDAR sensors 246 measures a distance of a target, for example the incoming or preceding vehicles, using short-pulsed laser. Measurements of the LIDAR may be used by the control hub 202a to detect and determine distance and position of the incoming and preceding vehicles.

The one or more cameras 248 are used capture images and videos around the vehicle. The control hub 202a may analyze images and/or videos from the one or more cameras 248 to detect incoming and preceding vehicles and calculating positions of the surrounding vehicles by incorporating measurements from other sensors.

During operation, the vehicle lighting system 200a may achieve ADB by switching between modular lights with low beam pattern in the light group 208a and modular lights with high beam pattern in the light group 208b.

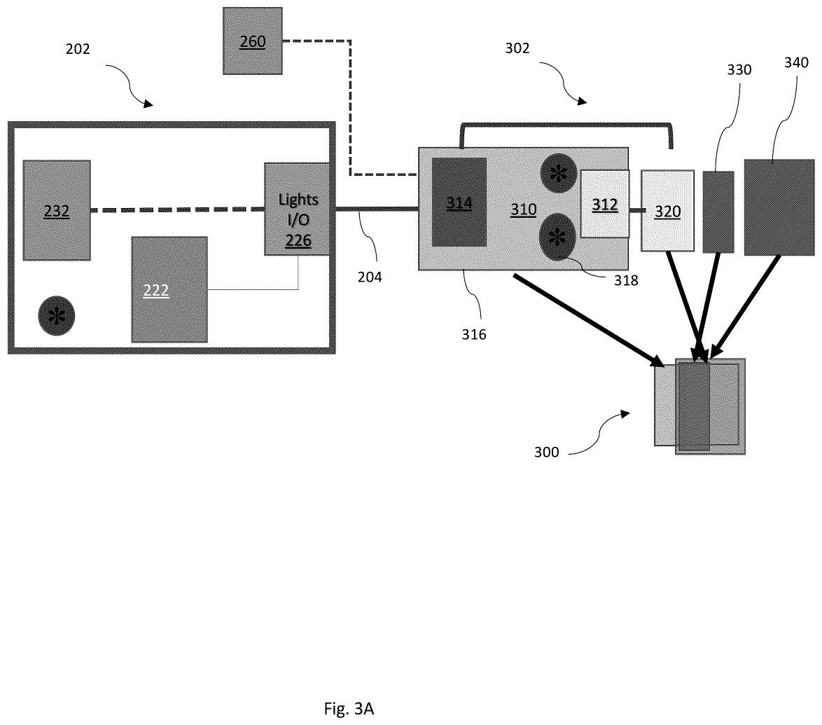

FIG. 3A is a schematic block graph of a modular light 300 according to embodiments of the present disclosure. The modular light 300 may be installed on a suitable position on a vehicle and connected to the vehicle lighting system 200, 200a described the above. The modular light 300 may include a light source module 310, an optic module 320, an assemble frame module 330, and a decorative frame module 340.

The light source module 310 may include one or more light chips 312 configured to project light beams, and a drive circuit 314 configured to drive the Light chip 312. The light chips 312 may be any suitable light source, such as a LED (light emitting diode) chip, a laser chip, or a combination of various chips.

The drive circuit 314 and the light chips 312 are disposed on a printed circuit board. In some embodiments, the drive circuit 314 and the light chip 312 are disposed on the same circuit board. In other embodiments, the drive circuit 314 and the light chips 312 are disposed on separated circuit boards according to the design. The light source module 310 may include a housing 316. The drive circuit 314 and the light chip 312 are disposed inside the housing 316. The housing 316 may have a modular shape or include a modular adaptor to assemble with other modular components, such as the optic module 320, the assemble module 330. In some embodiments, the light source module 310 further includes a climate control device 318 configured to cool and/or heat the light chips 312 and the drive circuit 314. The climate control device 318 may include a heat sink, a ventilation fan, or a combination thereof. The climate control device 318 may be disposed inside the housing 316, outside the housing 316, or through the housing 316.

The light source module 310 further includes an interface or an adaptor to connect with the control hub 202 via a cable 204. The cable 204 includes wiring to convey control signals from the control hub 202 to the light source module 310. In some embodiments, the cable 204 may include a power supply line to the light source module 310. Alternatively, the light source module 310 may be connected to an external power supply 260 without going through the control hub 202.

The optic module 320 may include one or more optical structures configured to receive and project a light beam to a certain illuminating pattern. The optic module 320 may include optical lens, reflectors, or a combination thereof. In some embodiments, the optic module 320 may include a mounting bracket to mount on the light source module 310. When assembled on a light source module 310, the optic module 320 is positioned to project a light beam from an illuminating pattern.

When assembled together, the light source module 310 and the optic module 320 may be referred to as a light core 302. Depending on the light source module 310 and the optic module 320, a light core 302 may function as various vehicle lights.

In some embodiments, the light core 302 may be pre-assembled together. Pre-assembly may be convenient for commonly used vehicle lights, such as low beam headlamps, high beam headlamps, fog lights, break lights, and the like. Pre-assembled light core 302 may provide precise alignment between the light chip 312 in the light source module 310 and the optical structure in the optic module 320. Pre-assembly may also improve sealing for the light chips 312 and the optic structures.

Optionally, one or more light cores 302 may be mounted on an assemble frame module 330 to form a vehicle light assembly, for example a vehicle headlamp assembly. The assembly frame module 330 may be a frame structure having one or more mounting seats. Each mounting seat is configured to receive a light core 302 therein. Using a suitable assemble frame module 330, standard or customary vehicle light assemblies may be assembled by selecting and plugging in suitable light cores 302.

Various assemble frame modules 330 may be designed to enable the light cores 302 to be installed on various vehicles and/or at various locations of a vehicle. For example, a grille frame module may have an outer profile to allow the frame module to be plugged in a vehicle grille opening, and a standard inner opening to receive a light core 302. A cap assemble frame module may have an outer profile comply with an outer surface of a truck cap and one or more standard inner openings to receive one or more light cores 302. When assembled together, the cap assemble frame module and the one or more light cores 302 form a custom after-market cap mount light.

Optionally, the decorative frame module 340 may be attached to the assemble frame module 330. The decorative frame module 340 may function to provide ornamental features. In some embodiments, the decorative frame module 340 may be specific to make and model of vehicles, therefore, fitting the modular light 300 to the various vehicles of different make and models.

As shown in FIG. 3A, one or more light cores 302 may be used together with the assemble frame module 330 and the decorative frame module 340 and form the modular light 300.

Because the modular lights 300 according to the present disclosure are assembled together by modular components, when any of the modular components, for example the light source module 310 and the optical module 320, may be replaced and exchanged without affecting other components. Traditionally, when any part of a vehicle light with a LED light source is broken, the entire vehicle light has to be replaced. Therefore, the modular light 300 may be repaired, modified, or updated at a fraction of cost compared to conventional vehicle lights in the market. Additionally, modular components may be repurposed.

FIG. 3B is a schematic block graph of a modular light 300a according to embodiments of the present disclosure. The modular light 300a is similar to the modular light 300 except that the modular light 300a includes a light source module 310a without the drive circuit 314. The drive circuit 314 is located in the control hub 202. In some embodiments, the drive circuit 314 is built in the light I/O 226. Because the modular light 300a is typically exposed to an exterior environment while the control hub 202 is typically installed in an interior environment, positioning the drive circuit 314 may extend lifetime of the drive circuit 314 and the light chip 312, and lower cost of ownership of the modular light 300a.

It has been observed that the drive circuit of a LED chip typically consume about 15% to about 40% of the energy during operation of a LED light source. As temperature increases, the percentage of the power consumed by the drive circuit also increases. As a result, the efficiency of LED chip reduces when temperature of the drive circuit increases. By positioning the drive circuit 314 in the control hub 202, which is typically in a climate controlled environment, efficiency and life span of the light chip 312 will increase. Additionally, by separating the light chip 312 and the drive circuit 314, the cost of replacing the light source module 310 is further reduced. With the drive circuit 314 is removed from the light source module 310, the dimension of the light source module 310 can be reduced. Additionally, the climate control device 318 may also be reduced or simplified. The light source module 310 with reduced dimensions may be installed in tight spaces, such as along the narrow space in under a tailgate.

In some embodiments, the drive circuit 314 may be integrated in the light I/O 226 in the control hub 202. The drive circuit 314 may connected to the on-board power unit 232. Alternatively, the drive circuit 314 may be arranged in a printed circuit board independently from the light I/O 226, and replaced and repaired independently. In some embodiments, the drive circuit 314 may be connected to the external power 260.

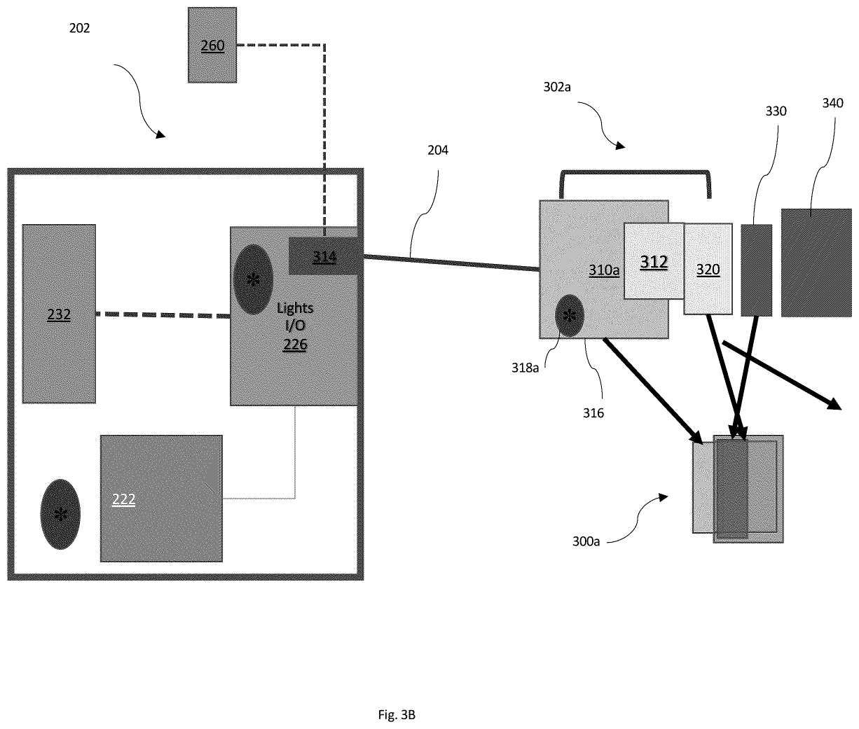

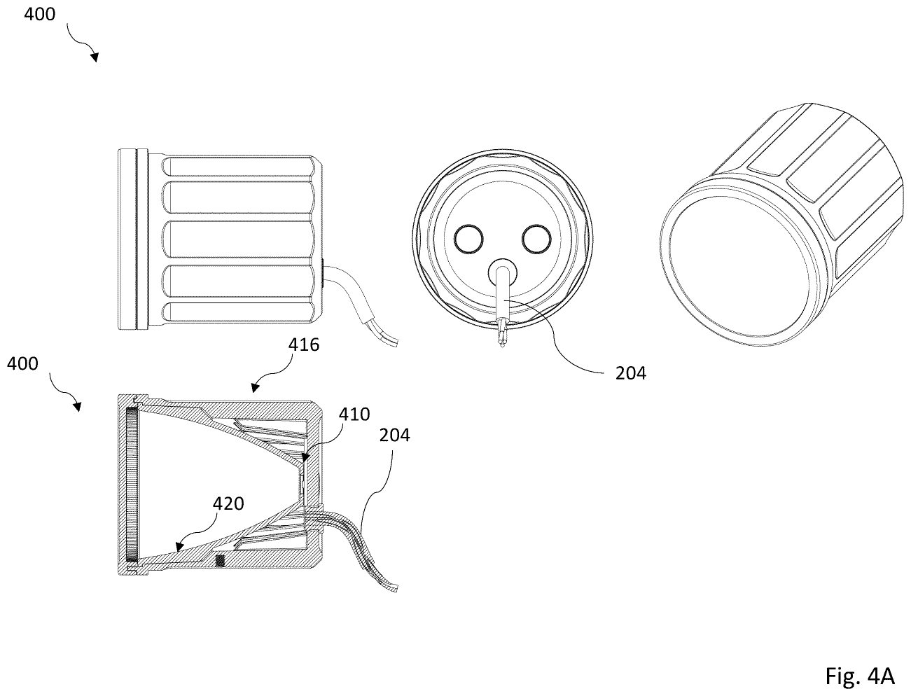

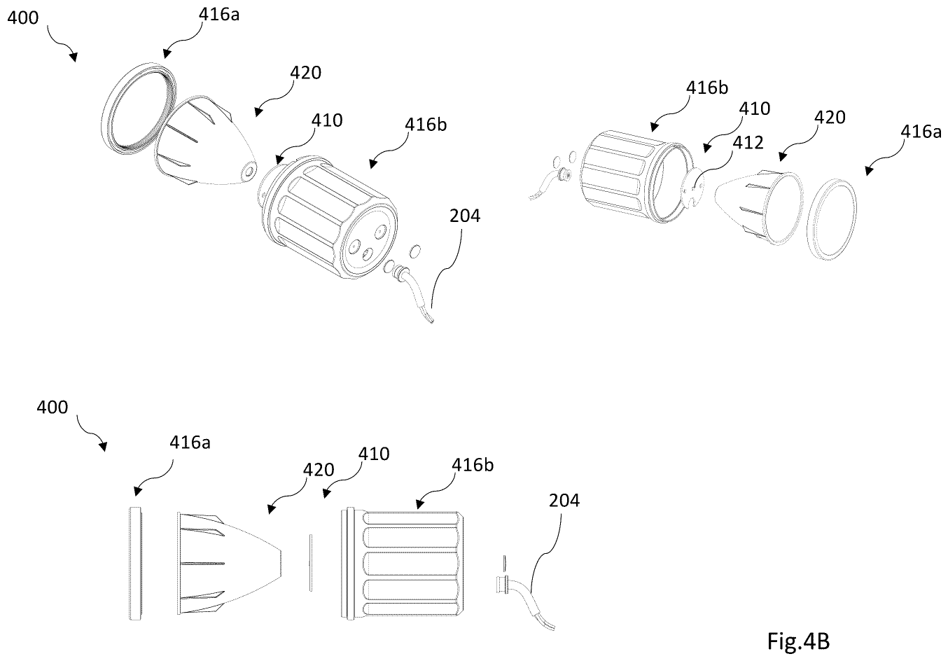

FIG. 4A includes various views of the exemplary modular light 400 according to the present disclosure. FIG. 4B includes exploded views of the modular light 400 of FIG. 4A. The modular light 400 is similar to the light core 302, 302a described above, and may be used to form various vehicle lights with an assemble frame module 330 and/or a decorative frame module 340. In some embodiments, the modular light 402 may be pre-assembled from a set of available light source modules 410 and optic modules 420.

The modular light 400 may include a light source module 410 and an optic module 420 installed to project light beams from the light source module 410 to one or more illumination patterns.

The light source module 410 may include one or more light chips 412 disposed on a printed circuit board. In some embodiments, the light source module 410 includes a drive circuit to the one or more light chips 412. In other embodiments, drive circuits to the one or more light chips 412 is located outside the modular light 400.

The optic module 420 includes optical structures of various designs. In the example shown in FIGS. 4A and 4B, the optic module 410 include a reflector and a lens. The optic module 420 is fixedly positioned relative to the light source module 410. For example, optical structures of the optic module 420 are fixedly positioned relative to the light chips 412 to project a desired illuminating pattern. In FIGS. 4A and 4B, the optic module 420 is substantially circular with a reflector cup. However, the optic module 420 may be other shapes. For example, the optic module 420 may have an elongated shape with two or more half cup reflectors, or may include a set of lenses of various shapes, or any combinations used by persons skilled in the art.

The modular light 400 further includes a housing 416 disposed over the light source module 410 and the optic module 420. The housing 416 provides protection and sealing to the light source module 410 and the optic module 420. In some embodiments, the housing 416 includes a front frame 416a and a back frame 416b. In some embodiment, the housing 416 may include a bracket or mounting feature to allow the modular light 400 to fit in assemble frame modules. The housing 416 shown in FIGS. 4A and 4B is substantially cylindrical. However, the housing 416 may be in any suitable shapes, such as elliptical, rectangular, linear, and the like.

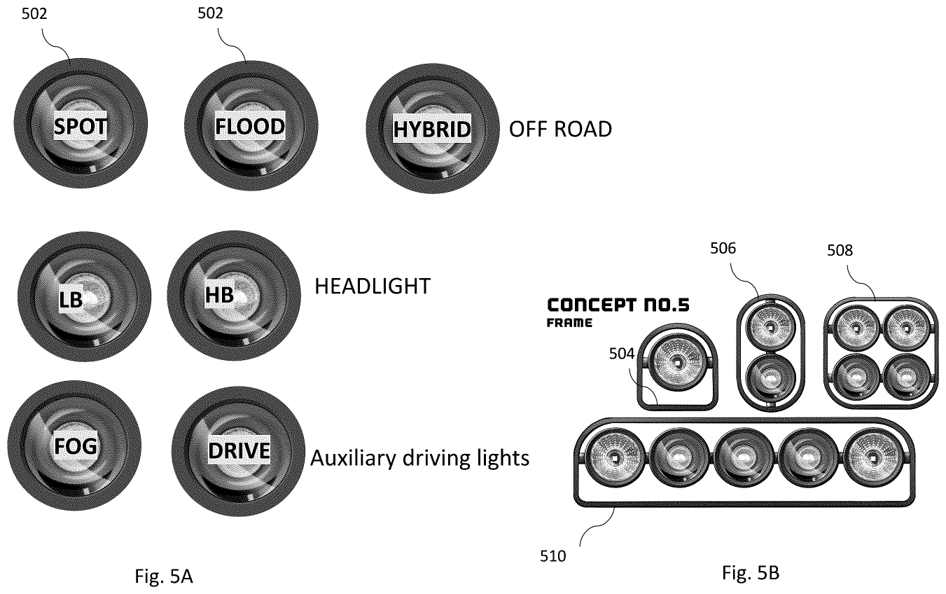

FIGS. 5A and 5B include examples of modular lights assembled with different combinations. In FIG. 5A, modular lights with various combinations of light source modules and optic modules, similar to the modular light 400, form individual lights for a vehicle,

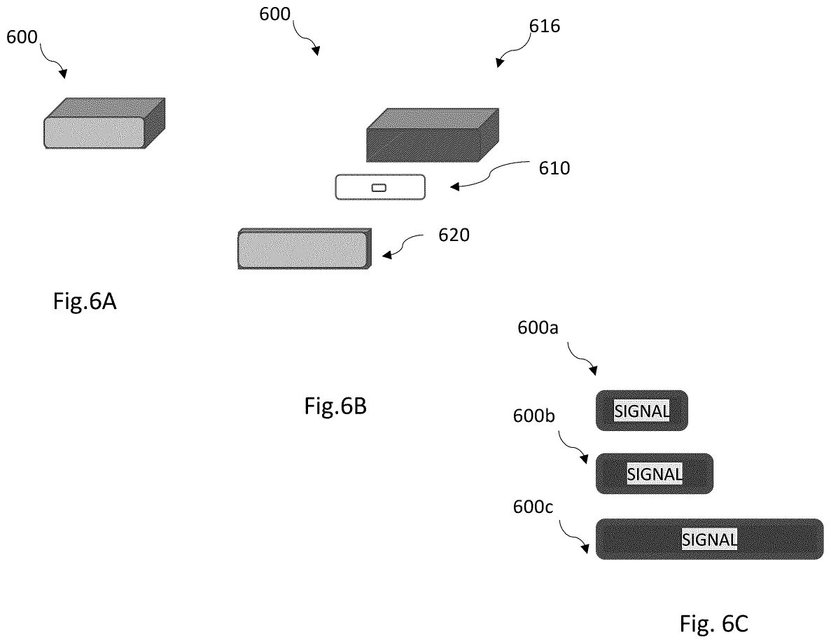

FIG. 6A—is a schematic perspective view of an exemplary modular signal light 600 according to the present disclosure. FIG. 6B is an exploded view of the modular signal light 600 of FIG. 6A. The modular signal light 600 may include a housing 615, a light source module 610, and a color filter module 620. The light source module 610 may include one or more LED chips. The light source module 610 may be configured to project light beams of various color. In some embodiments, the color filter module 620 may include colors designated for certain signals, such as yellow, red, white, and blue. By selecting different light source module 610 and color filter module 620, a modular signal light 600 may be used as various signal lights on a vehicle. The housing 616 may include a bracket or mounting feature to allow the modular signal light 600 to fit in assemble frame modules. In some embodiments, the modular signal light 600 has an elongated shape. However, the modular signal light 600 may be in any suitable shapes, such as circular, elliptical, squared, and the like.

FIG. 6C includes modular signal lights 600a, 600b, 600c of various shapes according to embodiments of the present disclosure. The modular signal lights 600a, 600b, 600c are similar in structure to the modular signal lights 600 but different in length. The different lengths of the modular signal lights 600a, 600b, 600c can be used to assemble signal lights of various shapes and to achieve various designs.

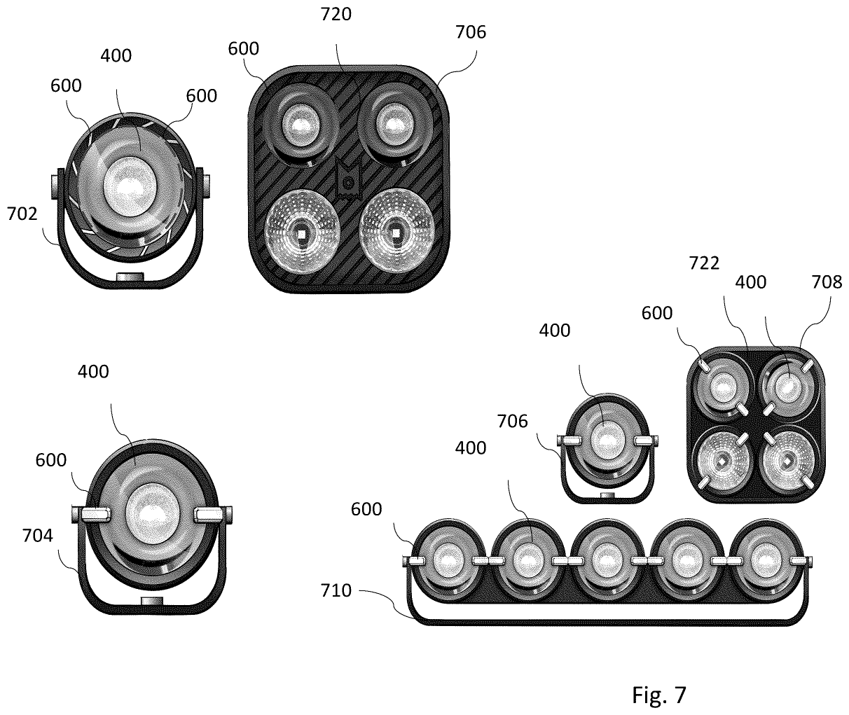

FIG. 7 includes various designs of vehicle lights assembled from modular lights 400, modular signal lights 600, assemble frames 702, 704, 706, 708, 710, and/or decorative frames 720, 722. As shown in FIG. 7, the vehicle lights are different in shapes and designs, and may be installed in various locations on a vehicles and function as various lights.

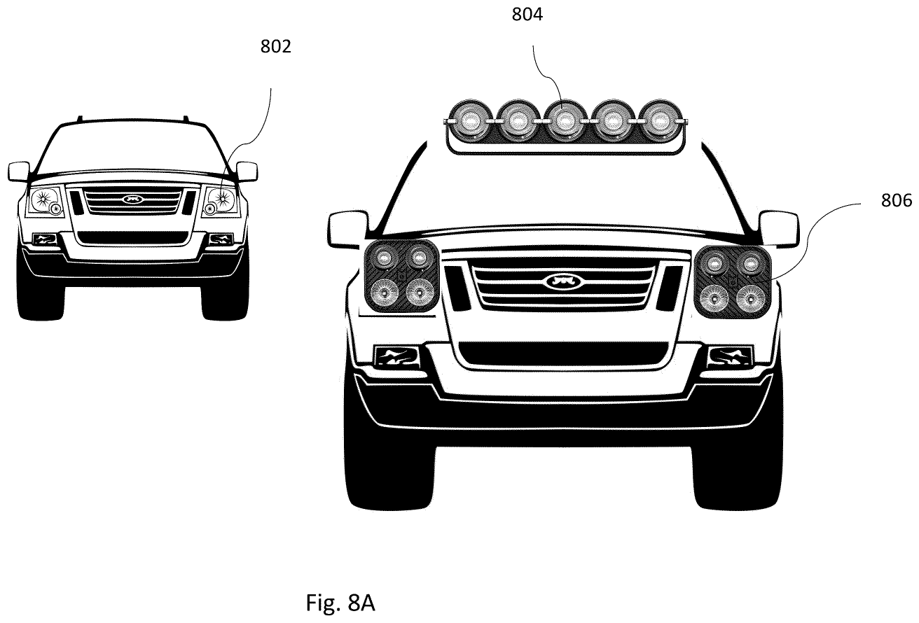

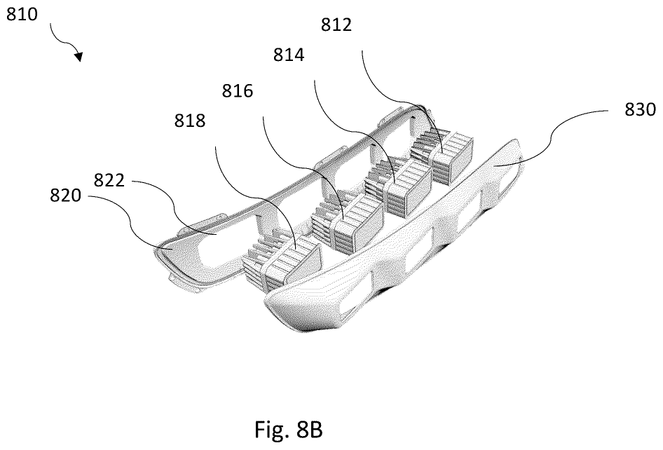

The vehicle lighting system and vehicle lights assembled from modules according to the present disclosure may be conveniently used in after-market vehicle lights. FIG. 8A schematically demonstrates various modular vehicle lights according to the present disclosure used as after-market vehicle lightings or off-road vehicle lights. As shown in FIG. 8A, OEM (original equipment manufacturer) headlights 802 on the vehicle are replaced by the modular headlights 804, and off-road modular lights 806 are added to the vehicle.

Modules according to the present disclosure may also be used by automakers as OEM lights. For example, FIG. 8B includes an explode view of an OEM headlight 810 assembled from modules according to the present disclosures. The OEM headlight 810 includes for modular lights 812, 814, 816, 818, an assemble frame module 820, and a decorative frame module 830. Each of the modular lights 812, 814, 816, 818 is similar to the light core 302 discussed above. The modular lights 812, 814, 816, 818, assembled from light source modules and optic modules, are substantially the same shape but function as high beam, low beam, spotlight, and fog light respectively. The assemble frame module 820 may have an exterior shape to integrate into the vehicle design and interior openings 822 to receive and secure the modular lights 812, 814, 816, 818. The decorate frame module 830 fits over the modular lights 812, 814, 816, 818 and the assemble frame module 820 with the design elements particular to the vehicle.

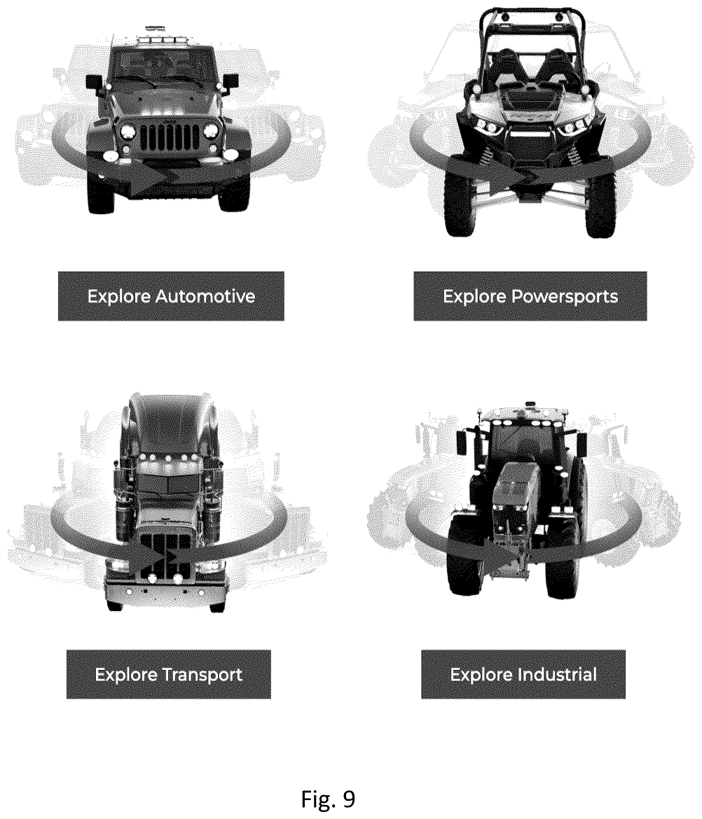

The vehicle lighting system and vehicle lights assembled from modules according to the present disclosure may be conveniently used as lightings for various vehicles as driving lights, signals, work lights. FIG. 9 includes various type of vehicles on which the vehicle lighting systems according to the present disclosure may be used, for example consumer automotive, power sports vehicles, transport vehicles, and industrial vehicles.

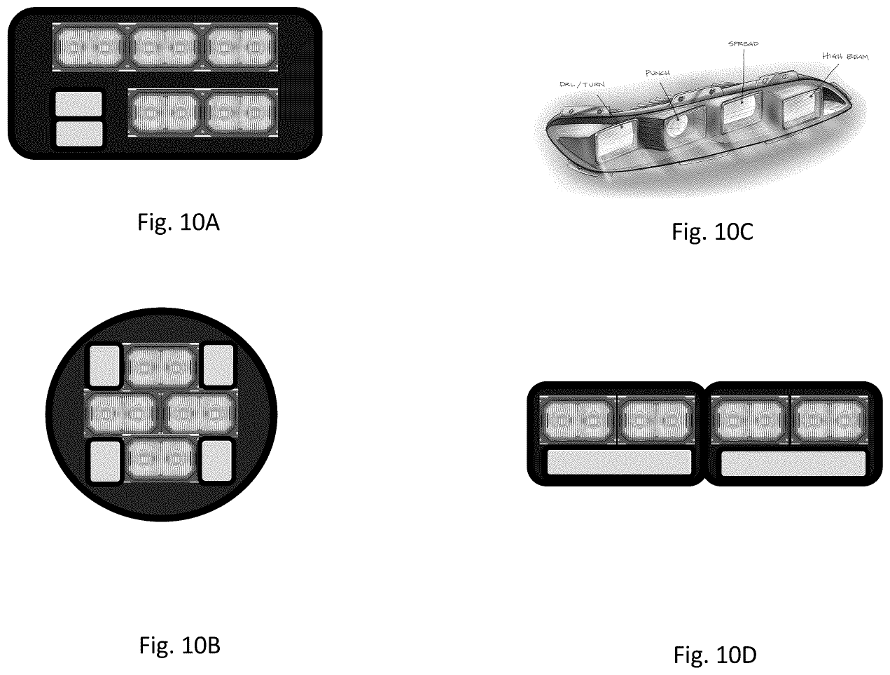

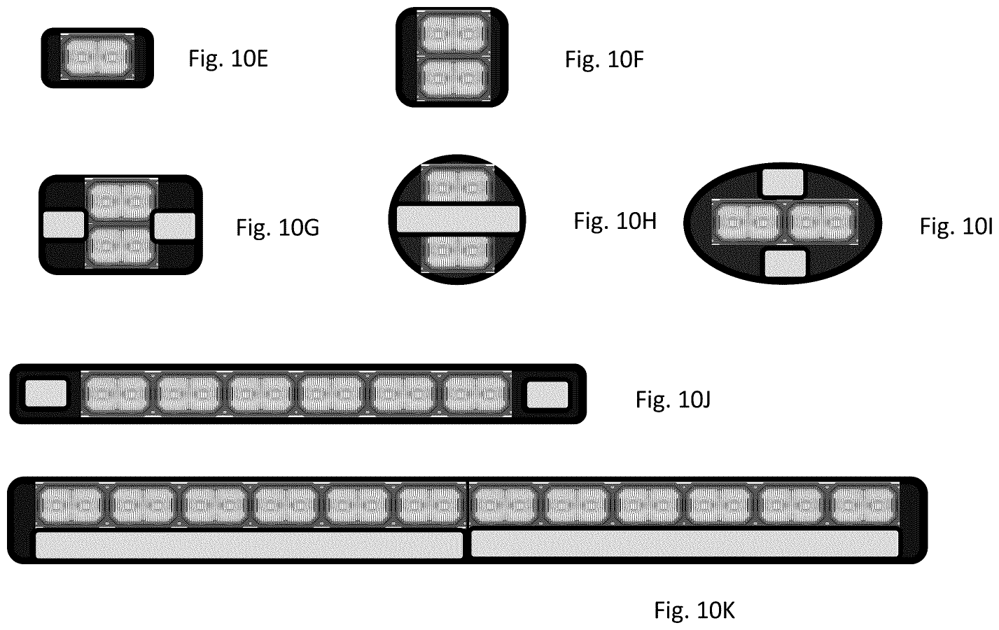

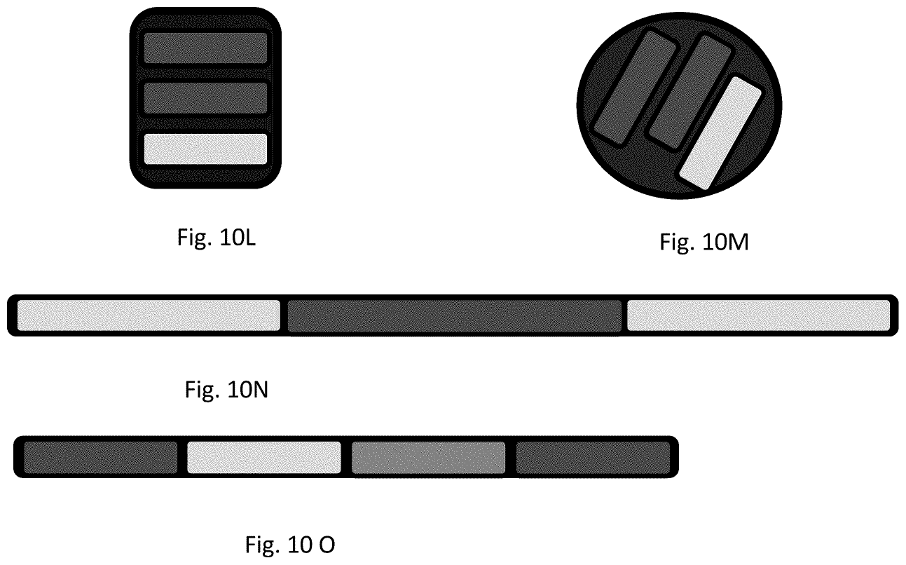

FIGS. 10A-100 are various exemplary modular lights according to present disclosure. FIGS. 10A-10D are examples of various headlight assembled from various modules according to embodiments of the present disclosure. FIGS. 10E-10K are examples of various auxiliary driving lights and off-road lights assembled from various modules according to embodiments of the present disclosure. FIGS. 10L-100 are examples of various signal and warning lights assembled from various modules according to embodiments of the present disclosure.

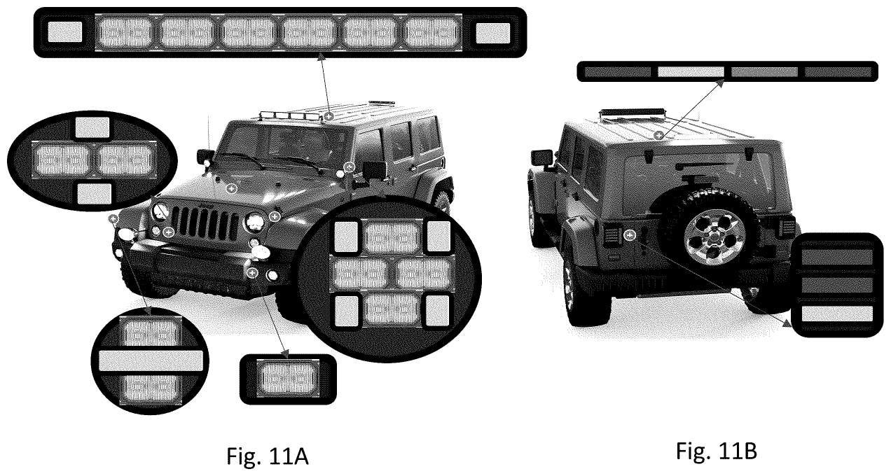

FIGS. 11A and 11B schematically demonstrate the exemplary modular lights of FIGS. 10A-100 installed on a consumer vehicle.

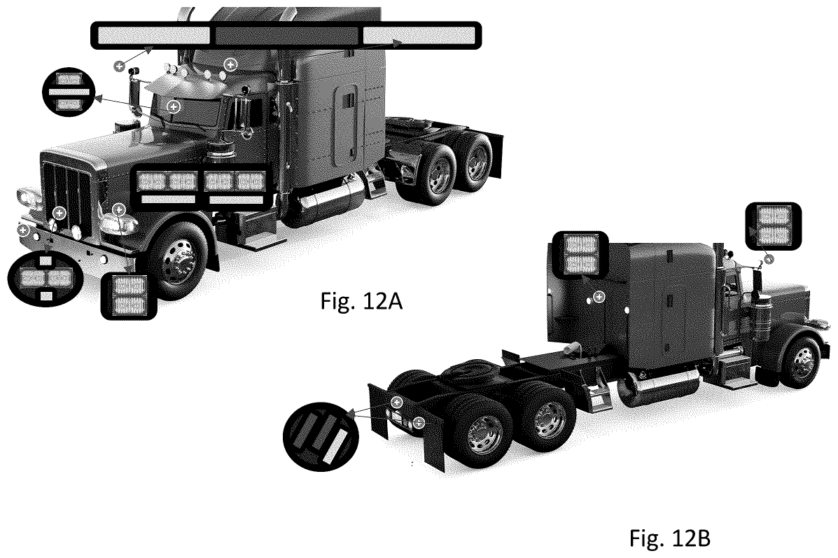

FIGS. 12A and 12B schematically demonstrate the exemplary modular lights of FIGS. 10A-100 installed on a commercial transport vehicle.

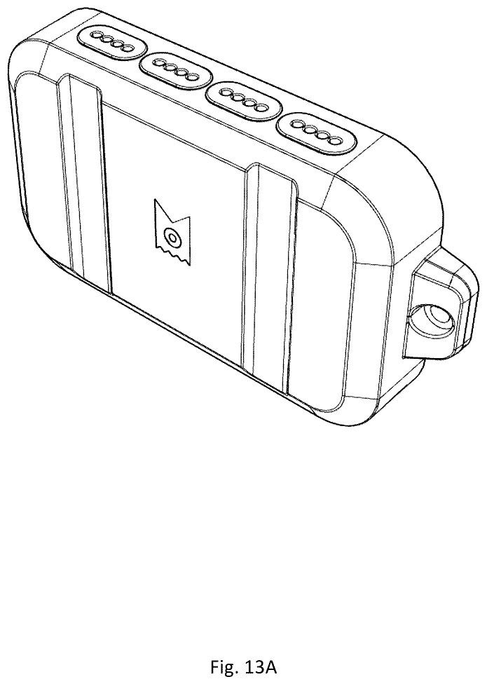

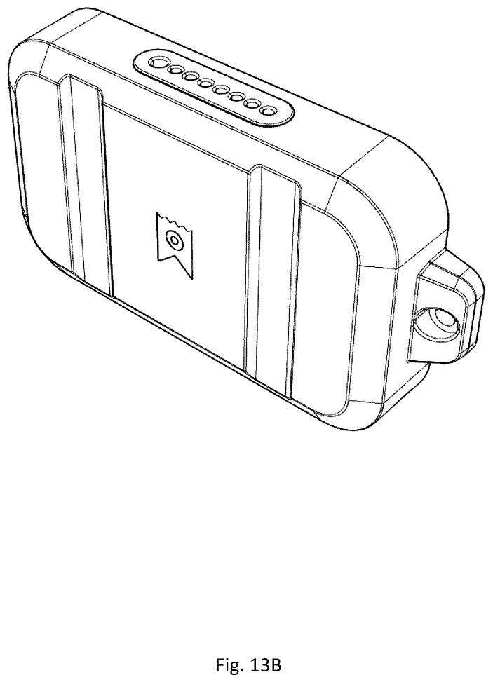

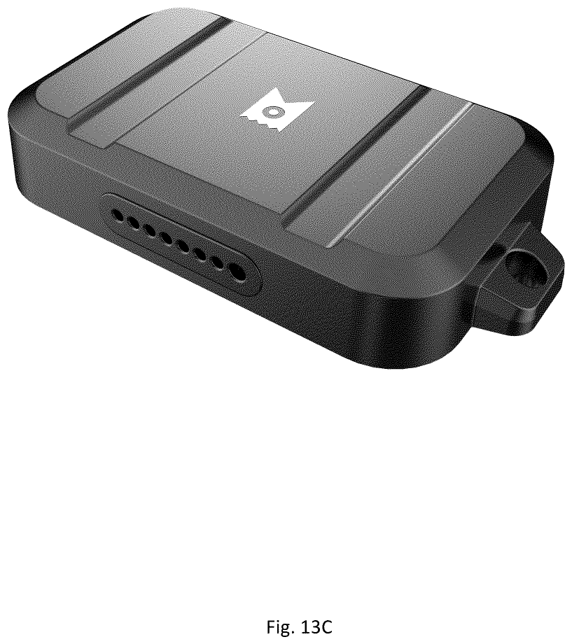

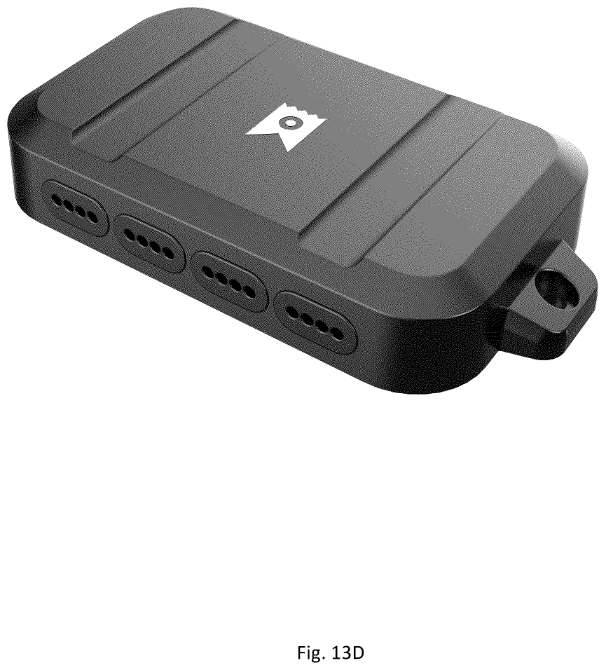

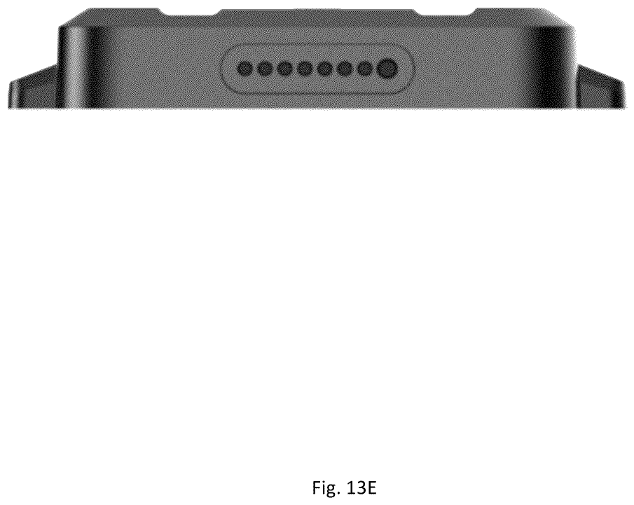

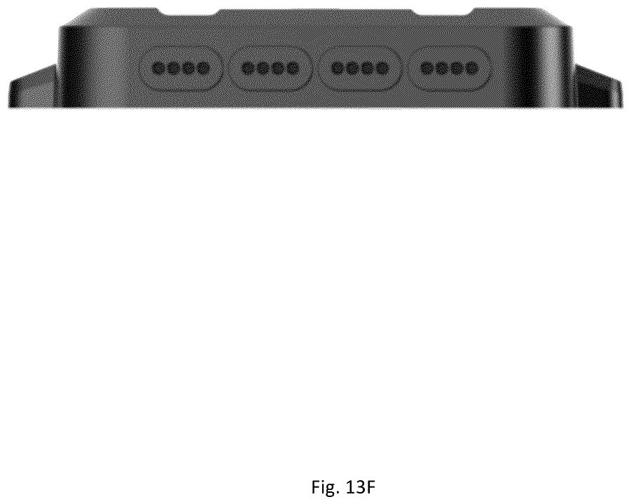

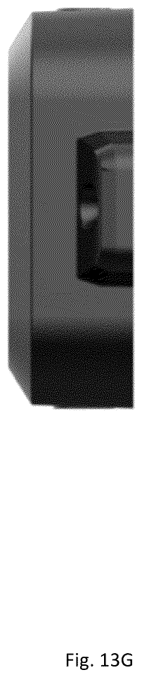

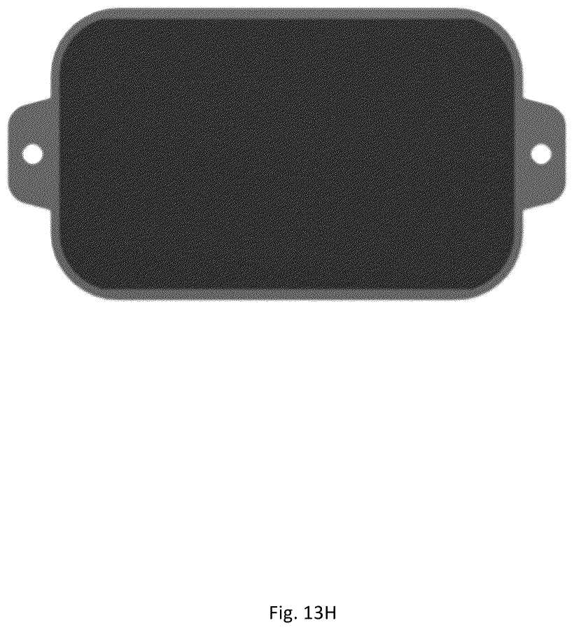

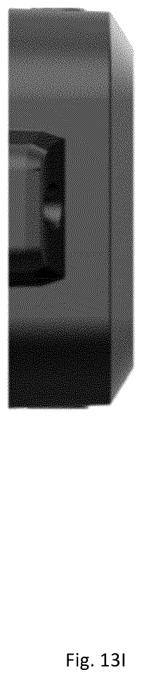

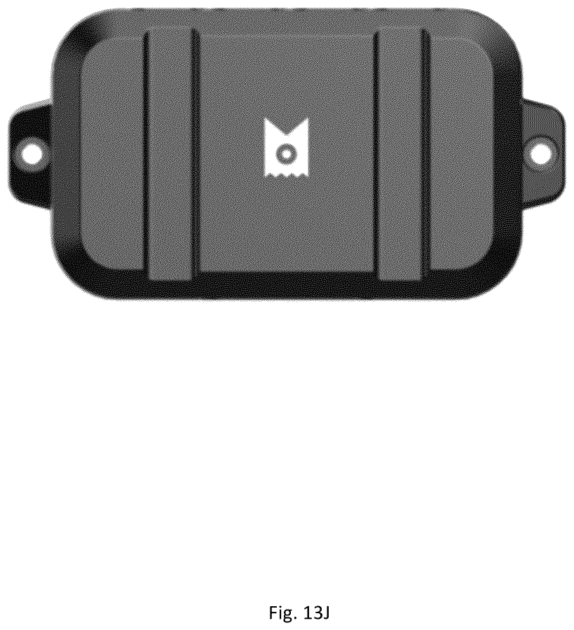

FIGS. 13A-13J schematically demonstrate a control box according to the present disclosure. The control box may be used to control and coordinate various vehicle lights. In some embodiments, the control box of FIG. 13A-13J may function as the control hub 202 shown in FIGS. 2A-2C.

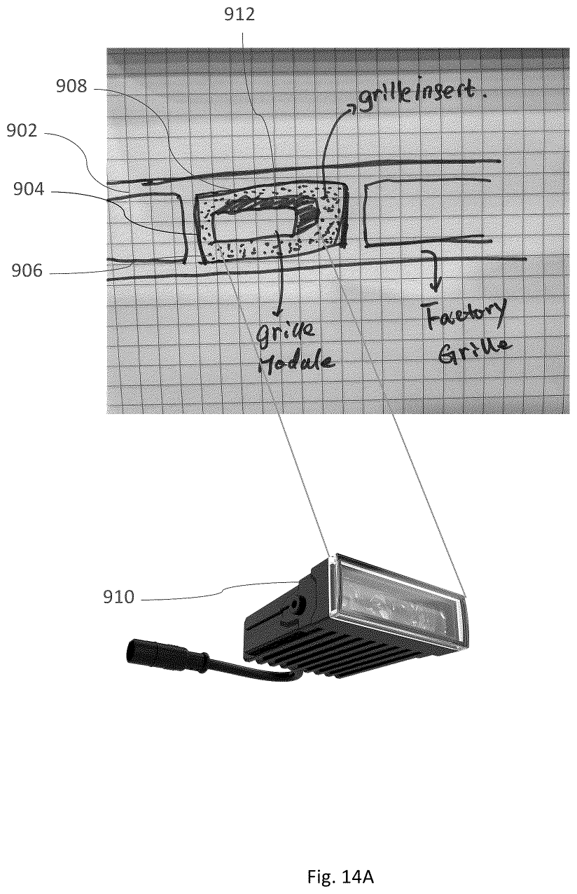

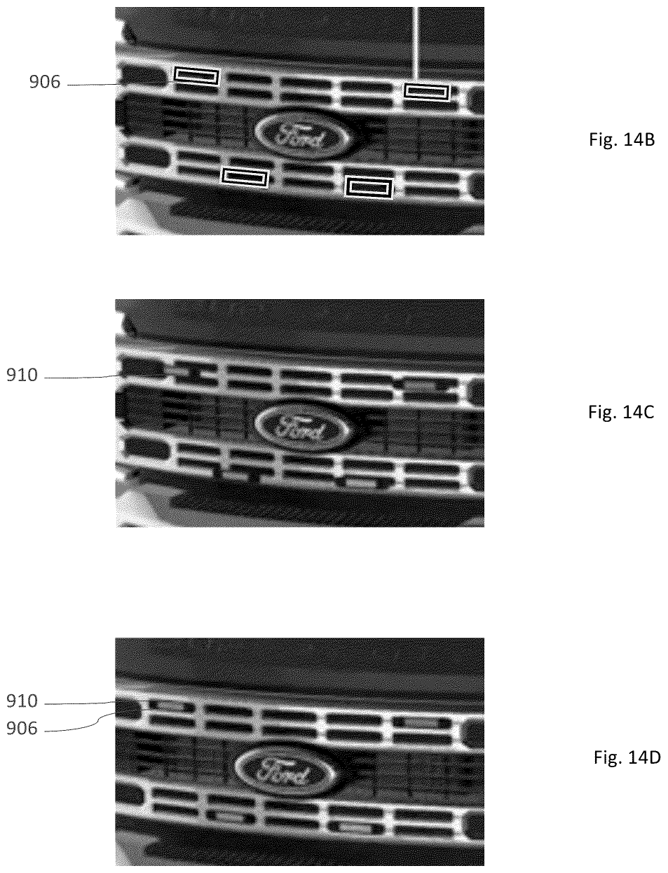

FIGS. 14A-14D schematically demonstrate one application of modular vehicle lights according to the present disclosure. Particularly, FIGS. 14A-14D demonstrate modular lights installed in grille openings. As shown in FIG. 14A, a modular light 910 is installed in a factory grille 902 without modification. Conventionally, when after-market lights on a grille of a vehicle, it is necessary to modify the factory grille or replacing the factory grille with a custom grille.

In the example of FIGS. 14A-14D, the modular light 910 is installed in an opening 904 of the factory grille 902. The modular light 910 may be similar to one of the modular lights 302, 302a, 400, 600, 812, 814, 816, 818 described above. As discussed, the modular lights 910 may have a standard shape and dimension. The grille 902 includes multiple openings 904. The shape and dimension of the openings 904 are usually depending on the make, model, and trim of the vehicle.

In some embodiments, a grille mount module 906 is used to enable installation of the modular light 910. The grille mount module 906 has an outer profile 908 matching the profile of the grille opening 904 and an inner opening 912 configured to receive the modular light 910 therein. The outer profile 908 of the grille mount module 906 is vehicle specific while the inner opening 912 is standard matching the modular light 910.

FIGS. 14B-14D schematically demonstrate an assemble process of installing the modular lights 910 into a factory grille. In FIG. 14B, the grille mount modules 906 are inserted into openings of the factory grille. In FIG. 14C, the modular lights 910 are inserted into the inner openings 912 of the grille mount modules 906. In FIG. 14D, the modular lights 910 are installed in the factory grille.

In the example of FIGS. 14A-14D, a mount module having an outer profile matching an existing opening, such as a grille opening, is used to mount the modular lights according to the present disclosure. Additionally, mount modules having a profile matching an outer profile, such as a tailgate or a cap top, may be used to mount the modular lights according to the present disclosure.

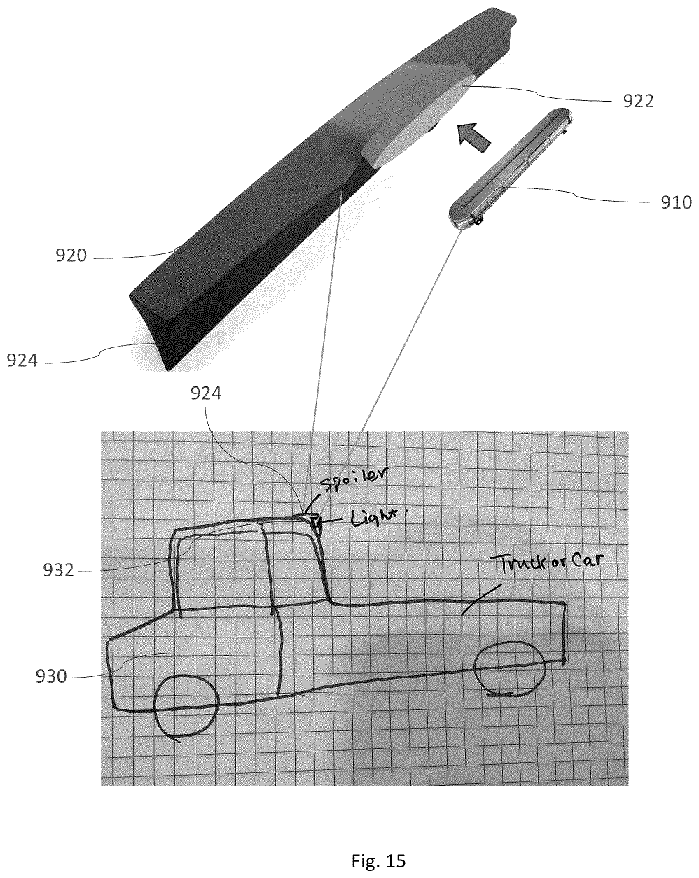

FIG. 15 schematically demonstrates another application of the modular vehicle lights according to the present disclosure. In FIG. 15, a spoiler mount module 920 is used to mount one or more modular light 910 on a vehicle 930. The vehicle 930 has a cap profile 932. The spoiler mount module 920 has an outer profile 924 substantially matching the cap profile 932 so that the spoiler mount module 920 may be seamlessly attached to the vehicle 930. The spoiler mount module 920 includes an opening 922 shaped to receive the modular light 910 therein. The outer profile 924 is vehicle specific while the inner opening 922 is standard to match the modular light 910.

Mount modules of other designs, such as taillights, may be used to install the modular lights according to disclosure.

While the foregoing is directed to embodiments of the present disclosure, other and further embodiments of the disclosure may be devised without departing from the basic scope thereof.

1. A vehicle lighting system, comprising:
a control hub;
one or more input/output adaptors connected to the control hub, wherein each of the input/output adaptor is configured to connect with a modular light; and
a control panel connected to the control hub.

2. The vehicle lighting system for claim 1, further comprising:
one or more sensors connected to the control hub, wherein the control hub receives measurements from the one or more sensors and sends to the modular lights based on received measurements to generate adaptive drive beams.

3. The vehicle lighting system for claim 1, further comprising:
a drive circuit remotely disposed from the modular light.

4. A modular light, comprising:
a light source module;
an optical module; and
an assembly frame module.

5. The modular light of claim 4, further comprising:
a decorative frame module.

6. The modular light of claim 4, wherein the light source module comprises:
a printed circuit board;
a light chip disposed on the printed circuit board; and
a drive circuit of the light chip disposed on the printed circuit board.

7. The modular light of claim 4, wherein the light source module comprises:
a printed circuit board;
a light chip disposed on the printed circuit board; and
an adaptor for receiving driving current from a remotely disposed drive circuit.

8. A vehicle light installation frame, comprising:
a body having an outer profile and an inner opening, wherein the outer profile is shaped to match an exterior portion of a vehicle, and an inner opening configured to receive a modular vehicle light.

9. The vehicle light installation frame of claim 8, wherein the outer profile matches an opening in a factory grille.

10. The vehicle light installation frame of claim 8, wherein the body is a spoiler.
